(19) United States
(12) Patent Application Publication
(10) Pub. No.: US 2008/0317346 A1
(43) Pub. Date: Dec. 25, 2008

(54) Character and Object Recognition with a Mobile Photographic Device

(75) Inventor: Jonathan A. Taub, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/766,195

(22) Filed: Jun. 21, 2007

(51) Int. Cl. G06K 9/18

(52) U.S. Cl. 382/182; 348/222.1

(57) ABSTRACT

Character and object recognition are provided from digital photography followed by digitization and integration of recognized textual and non-textual content into a variety of software applications for enabling use of data associated with the photographed content. A digital photograph may be processed by an optical character recognizer or optical object recognizer for generating data associated with a photographed object. A user of the photographed content may tag the photographed content with descriptive or analytical information that may be used for improving recognition of the photographed content and that may be used by subsequent users of the photographed content. Data generated for the photographed object may then be passed to a variety of software applications for use in accordance with respective application functionalities.

### BACKGROUND OF THE INVENTION

On a daily basis, people in professional, social, educational and leisure activities am exposed to textual and non-textual information, for example, road signs, labels, newspaper headlines, natural and man-made structures, geographical settings, and the like. Often a user would like to make quick use of such textual and non-textual information, but they have no means for utilizing the information in an efficient manner. For example, a user may see a road sign, landmark or other site or object and may wish to obtain directions from this site to a target location. If the user has access to a computer, he or she may be able to manually type or otherwise enter the address he or she reads from the road sign or identifying information about a landmark or other object into an automated map/directions application, but if the user is in a mobile environment, entering such information into a mobile computing device can be cumbersome and inefficient, particularly when the user must type or electronically handwrite the information into a small user interface of his or her mobile computing device. If the user does not have access to textual information, for example, text on a road sign, or if the user does not know or is otherwise unable to describe identifying characteristics of the site or other object then entry of such information into a mobile computing device becomes impossible.

It is very common for a user to photograph, such textual and non-textual objects with a mobile photographic computing/communication device, such as a camera-enabled mobile telephone or other camera-enabled mobile computing device, so to he or she may make use of the photographed information at a later time. While photographic images of such objects may be stored and transferred between computing devices, data associated with the photographed objects, for example, text on a textual object or ideality of a natural or man-made object is not readily available and useful to the photographer in any automated or efficient manner.

In addition, a photographer of a textual or non-textual object may desire to annotate the photographed textual or non-textual object with data such as a description, analysis, review or other information that may be helpful to others subsequently seeing the same textual or non-textual object. While prior photographic systems may allow the annotation of a photograph with a title or date/time, prior systems do not allow for the annotation of a photograph with information that may be used by subsequent applications for providing functionality based on the content of the annotation.

It is with respect to these and other considerations that the present invention has been made.

### SUMMARY OF THE INVENTION

This summary is provided to introduce a selection of concepts in a simplified form that are further described below in the detailed description. The summary is not intended to identify key features or essential features of the claimed subject matter, nor is it intended as an aid in determining the scope of the claimed subject matter.

Embodiments of the present invention solve the above and other problems by providing character and object recognition from digital photography followed by digitization and integration of recognized textual and non-textual content into a variety of software applications for enabling use of data and creating new data associated with the photographed content. According to embodiments of the invention, a digital photograph may be taken of a textual or non-textual object. The photograph may then be processed by an optical character recognizer or optical object recognizer for generating data associated with the photographed object. In addition to data generated about the photographed object by the optical character recognizer or optical object recognizer, the user taking the photograph may digitally annotate the object in the photograph with additional data, such as identification or other descriptive information for the photographed object, analysis of the photographed object, review information for the photographed object, etc. Data generated about the photographed object (including identifying information) may then be passed to a variety of software applications for use in accordance with respective application functionalities.

The textual information photographed from an object may be processed by an optical character recognizer, or non-textual information, such as structural features, photographed from a non-textual object, such as a famous landmark (e.g., the Seattle Space Needle), may be processed by an optical object recognizer. The resulting processed non-textual object or recognized text may be passed to a search engine, navigation application or other application for making use of information recognized for the photographed image. For example, a textual address or recognized landmark may be used to find directions to a desired site. For another example, a photographed drawing may be passed to a drawing application of computer assisted design application for making edits to the drawing or for using the drawing in association with other drawings. Information applied to the photographed textual or non-textual object by the photographer may be used for improving recognition of the photographed object, or for providing additional information to an application to which data for the photographed object is passed, or for providing helpful information to a subsequent reviewer of the photographed object.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a diagram of an example mobile computing device having camera functionality.

FIG. 2 is a block diagram illustrating components of a mobile computing device that may serve as an exemplary operating environment for embodiments of the present invention.

FIG. 3 is a simplified block diagram of a label that may be placed on a product package or other object.

FIG. 4A is a simplified block diagram of a sign containing textual information about an organization and its location.

FIG. 4B is a simplified block diagram illustrating a photograph of a non-textual object.

FIG. 4C is a simplified block diagram illustrating a photograph of an object containing both textual and non-textual information/features.

FIG. 5 illustrates a simplified block diagram of a computing architecture for obtaining information associated with recognized objects from a digital photograph.

FIG. 6 is a logical flow diagram illustrating a method for providing character and object recognition with a mobile photographic device.

FIG. 7 illustrates a simplified block diagram showing a relationship between a captured photographic image and one or more applications or services that may utilize data associated with a captured photographic image.

### DETAILED DESCRIPTION

As briefly described above, embodiments of the present invention are directed to providing character and object recognition from digital photography followed by digitization and integration of recognized textual and non-textual content into a variety of software applications for enabling use of data associated with the photographed content. A digital photograph may be processed by an optical character recognizer or optical object recognizer for generating data associated with a photographed object. A user of the photographed content may tag the photographed content with descriptive or analytical information that may be used for improving recognition of the photographed content and that may be used by subsequent users of the photographed content. Data generated for the photographed object may then be passed to a variety of software applications for use in accordance with respective application functionalities. The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

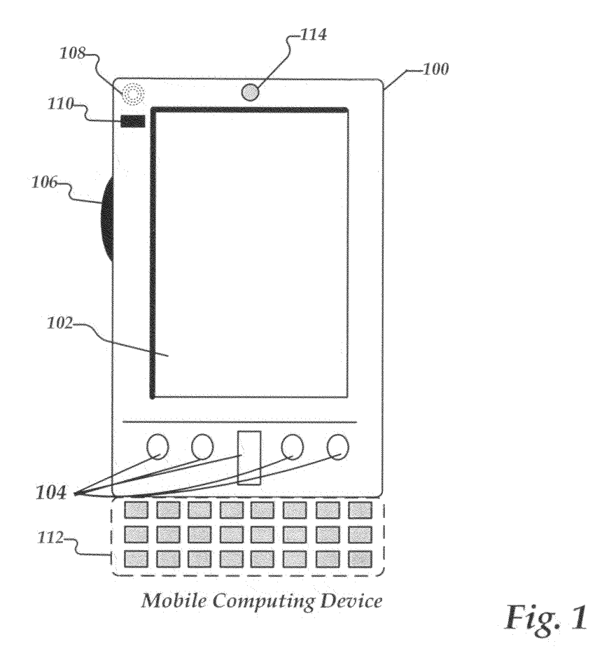

The following is a description of a suitable mobile device, for example, the camera phone or camera-enabled computing device, discussed above, with which embodiments of the invention may be practiced. With reference to FIG. 1, an example mobile computing device 100 for implementing the embodiments is illustrated. In a basic configuration, mobile computing device 100 is a handheld computer having both input elements and output elements. Input elements may include touch screen display 102 and input buttons 104 and allow the user to enter information into mobile computing device 100. Mobile computing device 100 also incorporates a side input element 106 allowing further user input. Side input element 106 may be a rotary switch, a button, or any other type of manual input element. In alternative embodiments, mobile computing device 100 may incorporate more or less input elements. For example, display 102 may not be a touch screen in some embodiments. In yet another alternative embodiment, the mobile computing device is a portable phone system, such as a cellular phone having display 102 and input buttons 104. Mobile computing device 100 may also include an optional keypad 112. Optional keypad 112 may be a physical keypad or a “soft” keypad generated on the touch screen display. Yet another input device that may be integrated to mobile computing device 100 is an on-board camera 114.

Mobile computing device 100 incorporates output elements, such as display 102, which can display a graphical user interface (GUI). Other output elements include speaker 108 and LED light 110. Additionally, mobile computing device 100 may incorporate a vibration module (not shown), which causes mobile computing device 100 to vibrate to notify the user of an event. In yet another embodiment, mobile computing device 100 may incorporate a headphone jack (hot shown) for providing another means of providing output signals.

Although described herein in combination with mobile computing device 100, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

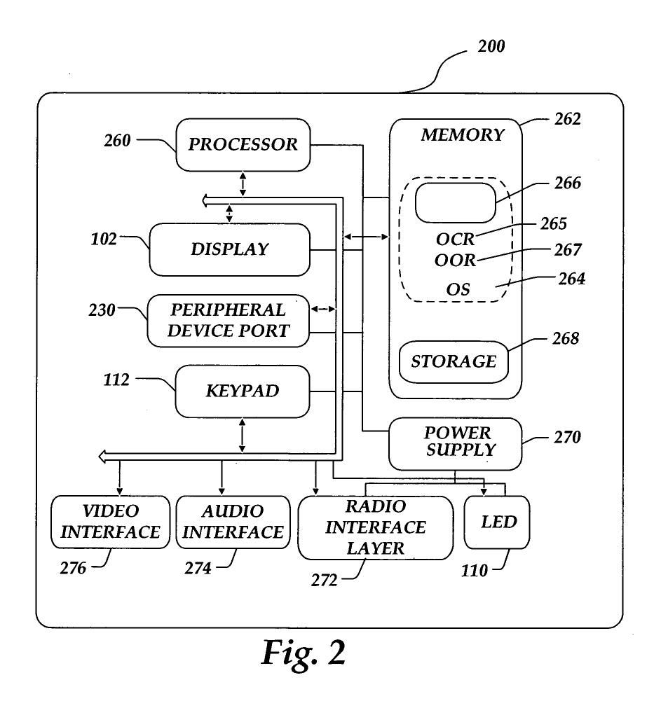

FIG. 2 is a block diagram illustrating components of a mobile computing device used in one embodiment, such as the computing device shown in FIG. 1. That is, mobile computing device 100 (FIG. 1) can incorporate system 200 to implement some embodiments. For example, system 200 can be used in implementing a “smart phone” that can run one or more applications similar to those of a desktop or notebook computer such as, for example, browser, email, scheduling, instant messaging, and media player applications. System 200 can execute an Operating System (OS) such as, WINDOWS XP®, WINDOWS MOBILE 2003® or WINDOWS CE® available from MICROSOFT CORPORATION, REDMOND, WASH. In some embodiments, system 200 is integrated, as a computing device, such as art integrated personal digital assistant (PDA) and wireless phone.

In this embodiment, system 200 has a processor 260, a memory 262, display 102, and keypad 112. Memory 262 generally includes both volatile memory (e.g., RAM) and non-volatile memory (e,g., ROM, Flash Memory, or the like). System 200 includes an Operating System (OS) 264, which in this embodiment is resident in a flash memory portion of memory 262 and executes on processor 260. Keypad 112 may be a push button numeric dialing pad (such as on a typical telephone), a multi-key keyboard (such as a conventional keyboard), or may not be included in the mobile computing device in deference to a touch screen or stylus. Display 102 may be a liquid crystal display, or any other type of display commonly used in mobile computing devices. Display 102 may be touch-sensitive, and would then also act as an input device.

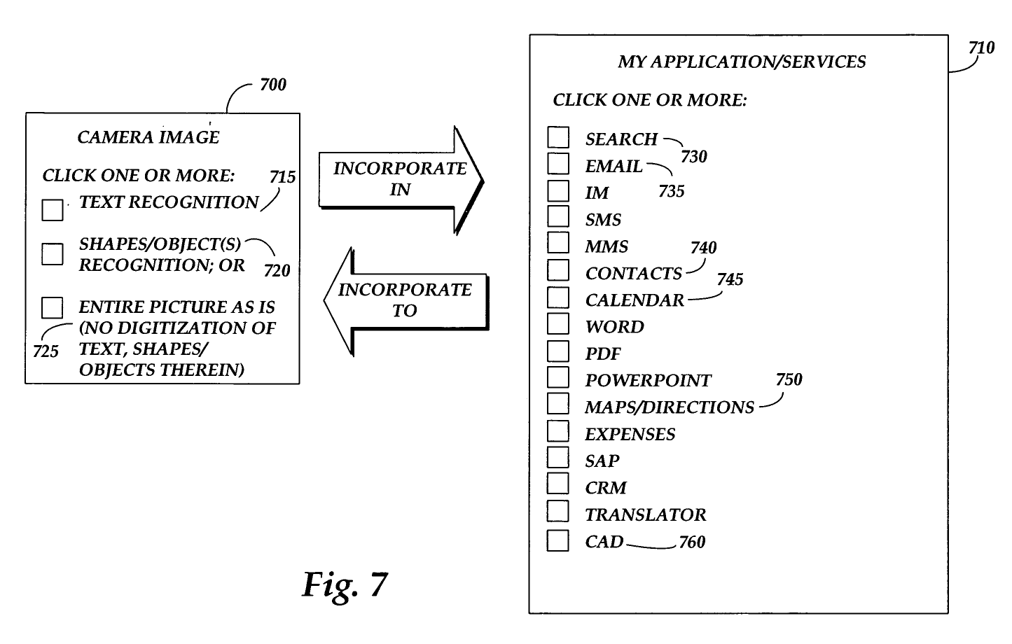

One or more application programs 266 are loaded into memory 262 and run on or outside of operating system 264. Examples of application programs include phone dialer programs, e-mail programs, PIM (personal information management) programs, word processing programs, spreadsheet programs. Internet browser programs, and so forth. System 200 also includes non-volatile storage 268 within memory 262. Non-volatile storage 268 may be used to store persistent information that should not be lost if system 200 is powered down. Applications 266 may use and store information in non-volatile storage 268, such as e-mail or other messages used by an e-mail application, contact information used by a PIM, documents used by a word processing application, and the like. A synchronization application (not shown) also resides on system 200 and is programmed to interact with a corresponding synchronization application resident on a host computer to keep the information stored in non-volatile storage 268 synchronized with corresponding information stored at the host computer. In some embodiments, non-volatile storage 268 includes the aforementioned flash memory in which the OS (and possibly other software) is stored. Other applications that may be loaded into memory 262 and run on the device 100 are illustrated in the mean 700, shown in FIG. 7.

According to an embodiment, an optical character reader/recognizer application 265 and an optical object reader/recognizer application 265 are operative to receive photographic images via the on-board camera 114 and video interface 276 for recognizing textual and non-textual information from the photographic images for use in a variety of applications as described below.

System 200 has a power supply 270, which may be implemented as one or more batteries. Power supply 270 might further include an external power source, such as an AC adapter or a powered docking cradle that supplements or recharges the batteries.

System 208 may also include a radio 272 that performs the function of transmitting and receiving radio frequency communications. Radio 272 facilitates wireless connectivity between system 200 and the “outside world”, via a communications carrier or service provider. Transmissions to and from radio 272 are conducted under control of OS 264. In other words, communications received by radio 272 may be disseminated to application programs 266 via OS 264, and vice versa.

Radio 272 allows system 200 to communicate with other computing devices, such as over a network. Radio 272 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein include both storage media and communication media.

This embodiment of system 200 is shown with two types of notification output devices; LED 110 that can be used to provide visual notifications and an audio interlace 274 that can be used with speaker 108 (FIG. 1) to provide audio notifications. These devices may be directly coupled to power supply 270 so that when activated, they remain on for a duration dictated by the notification mechanism even though processor 200 and other components night shut down for conserving battery power. LED 110 may be programmed to remain on indefinitely until the user takes action to indicate the powered-on status of the device. Audio interface 274 is used to provide audible signals to and receive audible signals from the user. For example, in addition to being coupled to speaker 108, audio interface 274 may also be coupled to a microphone to receive audible input, such as to facilitate a telephone conversation. In accordance with embodiments of the present invention, the microphone may also serve as an audio sensor to facilitate control of notifications, as will be described below.

System 200 may further include video interface 276 that enables an operation of on-board camera 114 (FIG. 1) to record still images, video stream, and the like. According to some embodiments, different data types received through one of the input devices, such as audio, video, still image, ink entry, and the like, may be integrated in a unified environment along with textual data by applications 266.

A mobile computing device implementing system 200 may have additional features or functionality. For example, the device may also include additional data storage devices (removable and/or non-removable) such as, magnetic disks, optical disks, or tape. Such additional storage is illustrated in FIG. 2 by storage 268. Computer storage media may include volatile and nonvolatile, removable and non-removable media implemented in any method or technology for storage of information, such as computer readable instructions, data structures, program modules, or other data.

Data/information generated or captured by the device 100 and stored via the system 200 may be stored locally on the device 100, as described above, or the data may be stored on any number of storage media that may be accessed by the device via the radio 272 or via a wired connection between the device 100 and a separate computing device (not shown) associated with the device 100, for example, a server computer in a distributed computing network such as the Internet. As should he appreciated such data/information may be accessed via the device 100 via the radio 272 or via a distributed computing network. Similarly, such data/information may be readily transferred between computing devices for storage and use according to well-known data/information transfer and storage means, including electronic mail and collaborative data/information sharing systems.

According to embodiments of the present invention, a mobile computing device 100, in the form of a camera-enabled mobile telephone and/or camera-enabled computing device (hereafter referred to as a “mobile photographic and communication device”), as illustrated above with reference to FIG. 1 and 2, may be utilized for capturing information via digital photography for utilizing the information with a variety of software applications.

If a photograph is taken by the mobile photographic and communication device 100 of a non-textual object, for example, a natural or man-made structure, for example, a mountain range, a famous building, an automobile, and the like, the digital photograph may be passed to an optical object reader/recognizer application 267 for identifying the photographed object. As with the optical character reader/recognizer, described below, the optical object reader/recognizer may be operative to enhance a received photograph for improving the recognition and identification process for the photographed non-textual object. According to one embodiment, the optical object reader/recognizer 267 is operative to select various prominent points on a photographed non-textual object and to compare the selected points with a library of digital images of other non-textual objects for identifying the subject object. For example, a well-known optical object reader/recognizer application is utilized by law enforcement agencies for matching selected points on a fingerprint with similar points on fingerprints maintained in a library of fingerprints for matching a subject fingerprint with a previously stored fingerprint.

According to art embodiment, the OOR application 267 may receive a digital photograph of a non-textual object, for example, a photograph of a human face or a photograph of the well-known object such as the Eiffel Tower in Paris, France, and the OOR application 267 may select a number of identifying points on the photograph of the example human face or tower for use in identifying the example face or tower from a library of previously stored images. That is, if certain points on the example human face or Eiffel Tower photograph are found to match a significant number of similar points on a locally or remotely stored image of the photographed human face or Eiffel Tower, then the OOR application 267 may return a name for the photographed human face or the “Eiffel Tower” as an identification associated with the photographed images. As should be appreciated the examples described herein are for purposes of illustration only and are not limiting of the vast number of objects that may be recognized by the OOR application 267.

The mobile photographic and communication device 100 may be utilized to digitally photograph textual content, for example, the text on a road sign, the text or characters on a label, the text or characters in a newspaper, menu, book, billboard, or any other object that may be photographed containing textual information. As will be described below, the photographed textual information may then be passed to an optical character reader/recognizer (OCR) 265 for recognizing the photographed textual content and for converting the photographed textual content to a format that may be processed by a variety of software applications capable of processing textual information.

Optical character reader/recognition software applications 265 are well known to those skilled in the art and need not be described in detail herein. In addition to capturing, reading and recognizing textual information, the OCR application 265 may be operative to enhance photographed textual content for improving the conversion of the photographed textual content into a format that may be used by downstream software applications. For example, if a photographed text string has shadows around the edges of one or more text characters owing to poor lighting for the associated photograph operation, the OCR application 265 may be operative to enhance the photographed text string to remove the shadows around the one or more characters so that the associated characters may be read and recognized more efficiently and accurately by the OCR application 265.

According to one embodiment, data from either the OOR application 267 or the OCR application 265 may be used to supplement recognition of a photographed object in conjunction with the other recognition application. For example, if a photograph is taken of a textual address displayed on a building, the non-textual features of the photographed building may be utilized by the OOR application 267 to assist in identifying the photographed building and to improve the accuracy of the OCR application 265 in recognizing the textual address information displayed on the photographed building. Similarly, textual information contained in a photograph of a non-textual object may be recognized by the OCR application 265 and may be used to entrance the recognition by the OOR application 267 of the non-textual features of the photographed object.

According to one embodiment, for both the OCR application 265 and the OOR application 267, if either application identifies a subject textual or non-textual content/object with more that one matching text string or stored image, multiple text strings and multiple images may be returned by the OCR application 265 and the OOR application 267, respectively. For example, if the OCR application 265 receives a photographed text string “the grass is green,” the OCR application 265 may return two possible matches for the photographed text string such as “the grass is green” and “the grass is greed.” The user may be allowed to choose between the two results for processing by a given application.

With regard to the OOR application 267, a digital photograph of the “Eiffel Tower” may be recognized by the OOR application 267 as both the Eiffel Tower and the New York RCA Radio Tower. As with the OCR application 265, a software application utilizing the recognition performed by the OOR application 267 may provide both possible matches/recognitions to a user to allow the user to choose between the two potential recognitions of the photographed object.

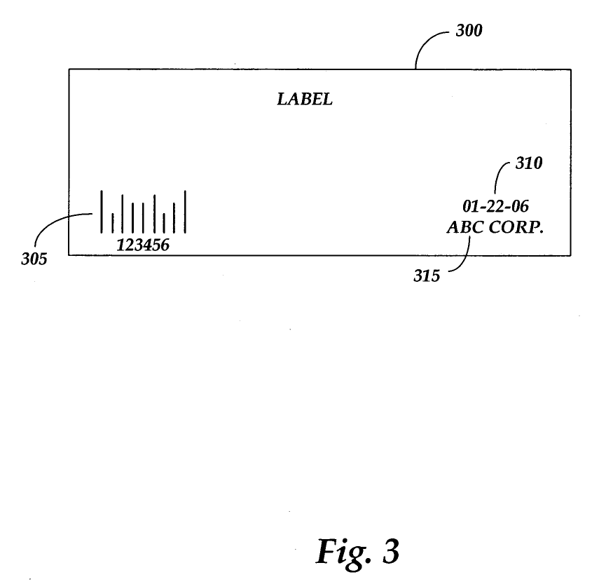

FIG. 3 is a simplified block diagram of a label that may be placed on a product package or other object. The label 300, illustrated in FIG. 3, has a bar code 305 with a numerical text string underneath the bar code. A label date 310 is provided, and a company identification 315 is provided. The label 300 is illustrated herein as an example of an object having textual and non-textual content that may be photographed in accordance with embodiments of the present invention. For example, a camera phone 100 may be utilized for photographing the label 300 and for processing the textual content and non-textual content contained on the label. For example, the non-textual bar code may be photographed and may be passed to the OOR application 267 for possible recognition against a database of bar code images. On the other hand, the textual content including the numeric text string under the bar code 305, the date 310, and the company name 315 may he processed by the OCR application 265 for utilization by one or more software applications, as described below.

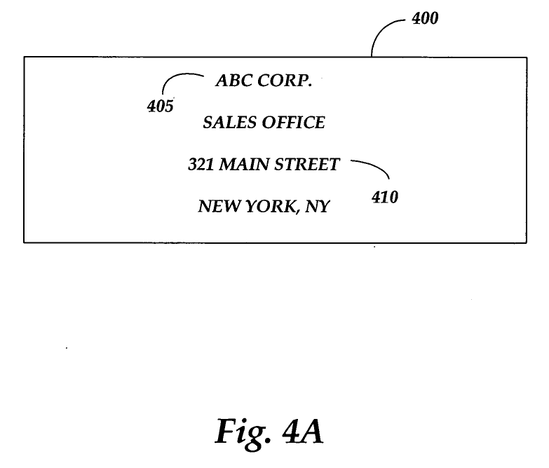

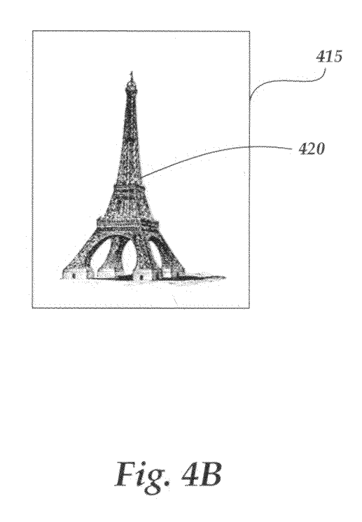

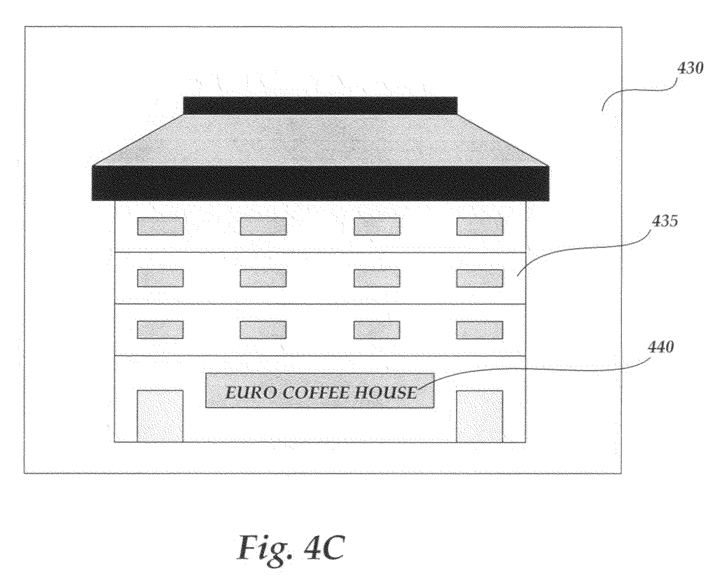

FIG. 4A is a simplified block diagram of a sign containing textual information about an organization and its location. FIG. 4A is illustrative of a sign, business card or other object on which textual content may be printed or otherwise displayed. According to embodiments of the present invention, a mobile photographic and communication device 100 may be utilized for photographing the object 400 and for processing the textual information via the OCR application 265 for use by one or more software applications as described below. As should be appreciated the objects illustrated in FIGS. 3 and 4 are for purposes of example only and are not limiting of the vast number of textual and non-textual images that may be captured and processed as described herein.

FIG. 4B is a simplified block diagram illustrating a photograph of a non-textual object. In FIG. 4B, an example digital photograph 415 is illustrated in which is captured an image of a well-known landmark 420, for example, the Eiffel Tower. As described above, the photograph of the example radio tower 420 may be passed to the optical object recognizer (OOR) application 267 for recognition. Identifying features of the example tower 420 may be used by the OOR application 267 for recognizing the photographed tower as a particular structure, for example, the Eiffel Tower. Other non-textual objects, for example, human faces, may be captured, and features of the photographed objects may likewise be used by the OOR application 267 for recognition of the photographed objects.

FIG. 4C is a simplified block diagram illustrating a photograph of an object containing both textual and non-textual information/features. In FIG. 4C an example digital photograph 430 is illustrated in which is captured an image of a building 435, and the building 435 includes a textual sign 440 on the front of the building bearing the words “Euro Coffee House.” As described above, data from either the OCR application 267 or the OCR application 265 may be used to supplement recognition of a photographed object in conjunction with the other recognition application. For example, if a photograph is taken of the building illustrated in FIG. 4C, the textual information (e.g., “Euro Coffee House”) displayed on the building may be passed to the OCR application 265, and the non-textual features of the photographed building 430 may be utilized by the OOR application 267 to assist in identifying the photographed building and to improve the accuracy of the OCR application 265 in recognizing the textual information displayed on the photographed building. For example, the textual words “Euro Coffee House” may not provide enough information to obtain a physical address for the building, but that textual information in concert with OOR recognition of non-textual features of the building may allow for a more accurate recognition of the object, including the location of the object by its physical address. Similarly, textual information contained in the photograph of the non-textual object, for example the building 430, may be recognized by the OCR application 265 and may be used to enhance the recognition by the OOR application 267 of the non-textual features of the photographed building.

According to one embodiment, information from either or both the OCR application 265 and the OOR application 267 may also be combined with a global positioning system or other system for finding a location of an object for yielding very helpful information to a photographing user. That is, if a photograph is taken of an object, for example, the building/coffee shop illustrated in FIG. 4C, the identification/recognition information for the object may be passed to or combined with a global positioning system (GPS) or other location finding system for finding a physical position for the object. For example, a user could take a picture of the building/coffee shop illustrated in FIG. 4C, select a GPS system from a menu of applications (as described below with reference to FIG. 7), obtain a position of the building, and then email the picture of the building along with the GPS position to a friend. Or, the identification information in concert with a GPS position for the object could be used with a search engine for finding additional interesting information on the photographed object.

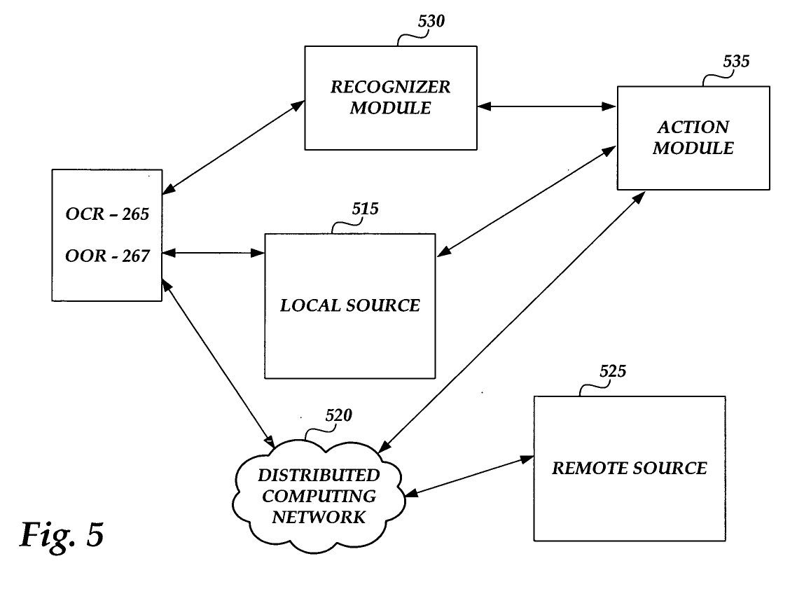

FIG. 5 illustrates a simplified block diagram of a computing architecture for obtaining information associated with recognized objects from a digital photograph. According to an embodiment, after a textual or non-textual object is read by either the OCR application 265 or the OOR application 267, the recognition process by which read textual objects or non-textual objects are recognized may be accomplished via a recognition architecture as illustrated in FIG. 5. As should be appreciated the recognition architecture illustrated in FIG. 5 may be integrated with each of the OCR application 265 and the OOR application 267, or the recognition architecture illustrated in FIG. 5 may be called by the OCR 265 and/or the OOR 265 for obtaining recognition of a textual or non-textual object.

According to one embodiment, when the OCR 265 and/or OOR 267 reads a textual or non-textual object, as described above, the read object may be “tagged” for identifying a type for the object which may then be compared against an information source applicable to the identified textual or non-textual object type. As described below, “tagging” an item allows the item to be recognized and annotated in a manner that facilitates a more accurate information lookup based on the context and/or meaning of the tagged item. For example, if photographed text string may be identified as a name, then the name may be compared against a database of names, for example, a contacts database, for retrieving information about the identified name, for example, name, address, telephone number, and the like, for provision to one or more applications accessible via the mobile photographic and communication device 100. Similarly, if a number string, for example, a five-digit number, may be identified as a ZIP Code, then the number string may similarly he compared against ZIP Codes contained in a database, for example, a contacts database for retrieving information associated with the identified ZIP Code.

Referring to FIG. 3, according to this embodiment, when textual content read by the OCR 265 or non-textual content read by the OOR 267 are passed to a recognizer module 530 the textual content or the non-textual content is compared against text or objects of various types for recognizing and identifying the text or objects as a given type. For example, if a test string is photographed from the label 300, such as the name “ABC CORP.,” the photographed text string is passed by the OCR 265 to tire recognizer module 530. At the recognizer module 530, the photographed text string is compared against one or more databases of text strings. For example, the text string “ABC CORP.” may be compared against a database of company names or contacts database for finding a matching entry. For another example, the text string “ABC CORP.” may be compared against a telephone directory for finding a matching entry in a telephone director. For another example, the text string “ABC CORP,” may be compared against a corporate or other institutional directory for a matching entry. For each of these examples, if the test string is matched against content contained in any available information source, then information applicable to the photographed text string of the type associated with the matching information source may be returned.

Similarly, a photographed non-textual object may be processed by the OOR application 267, and identifying properties, for example, points on a building or fingerprint, may be passed to the recognizer module 530 for comparison with one or more databases of non-textual objects for recognition of the photographed object as belonging to a given object type, for example, building, automobile, natural geographical structure, etc.

According to one embodiment, once a given text string or non-textual object is identified as associated with a given type, for example, a name or building, an action module 535 may be invoked for passing the identified text item or non-textual object to a local information source 515 or to a remote source 525 for retrieval of information applicable to the text string or non-textual object according to their identified types. For example, if the text string “ABC CORP.” is recognized by the recognizer module 530 as belonging to the type “name,” then the action module 535 may pass the identified text string to all information sources contained at the local source 515 and/or the remote source 525 for obtaining available information associated with the selected test string of the type “name.” If a photographed non-textual object is identified as belonging to the type “building,” then the action module 535 may pass the identified building object to information sources 515, 525 for obtaining available information associated with the photographed object of the type “building.”

Information matching the photographed text string from each available source may be returned to the OCR application 265 for provision to a user for subsequent use in a desired software application. For example, if the photographed text string “ABC CORP.” was found to match two source entries, “ABC CORP.” and “AEO CORP.” (the latter owing to a slightly inaccurate optical character reading), then both potentially matching entries may be presented to the user in a user interface displayed on his or her mobile photographic and communication device 100 to allow the user to select the correct response. Once the user confirms one of the two returned recognitions as the correct text string, then the recognized text string may be passed to one or more software applications as described below. Likewise, if a photographed building is identified by the recognition process as “St. Marks Cathedral” and as “St. Joseph's Cathedral,” both building identifications may be presented to the user for allowing the user to select a correct identification for the photographed building which may then be used with a desired software application as described below.

As should be appreciated, the recognizer module may be programmed for recognizing many data types, for example, book titles, movie titles, addresses, important dates, geographic locations, architectural structures, natural structures, etc. Accordingly, as should be understood, any textual content or non-textual object passed to the recognizer module 530 from the OCR application 265 or OOR application 257 that may be recognized and identified as a particular data type may be compared against a local or remote information source for obtaining information applicable to the photographed items as described above.

According to another embodiment, the recognizer module 530 and action module 535 may be provided by third parties for conducting specialized information retrieval associated with different data types. For example, a third-party application developer may provide a recognizer module 530 and action module 535 for recognizing text or data items as stock symbols. Another third-party application developer may provide a recognizer module 530 and action module 535 for recognizing non-textual objects as automobiles. Another third-party application developer may provide a recognizer module 530 and action module 535 for recognizing non-textual objects as animals (for example, dogs, cats, birds, etc.), and so on.

According to embodiments, in addition to textual and non-textual information recognized from a photographed object, new information regarding a photographed object may be created and digitally “tagged to” or annotated to the photographed object by the photographer for assisting the OOR application 267, the OCR application 265 or the recognizer module 530 in recognizing a photographed image. Such information tagged to a photographed object by the photographer may also provide useful descriptive or analytical information for subsequent users of the photographed object. For example, according to one embodiment, after an object is photographed, a user of the mobile photographic and communication device 100 may be provided an interface for annotating or tagging the photograph with additional information. For example, the mobile photographic and communication device 100 may provide a microphone for allowing a user to speak and record descriptive or analytical information about a photographed object. A keypad or electronic writing surface may be provided for allowing a user to type or electronically handwrite information about the photographed object. In either case, information tagged to the photographed object may be used to enhance recognition of the object and to provide useful information for a subsequent user of the photographed object.

For example, if a user photographs the CD cover of the well-known Beatles Abbey Road album, but the quality of the lighting or the distance between the camera and the photographed image make recognition by the OCR application 265 or OOR application 267 difficult or impossible (i.e., multiple or no results are presented from the OCR or OOR), the photographer may speak, type or electronically handwrite information such as “The Beatles Abbey Road CD.” This information may be utilized by a recognition system, such as the system illustrated in FIG. 5, to assist the OOR application 267 or OCR application 265 in identifying the photographed object as the Beatles Abbey Road album/CD. For another example, a photographer may tag information to a photographed object that is useful to a subsequent user of the photograph or photographed object. For instance, in the example above, the photographer may provide a review or other commentary on the Beatles Abbey Road CD. As another example, a photographer may photograph a restaurant, which after being recognized by the OCR/OOR applications or manually identified as described above, may be followed by annotation of the photograph with a review of the food at the restaurant. The review information for the example CD or restaurant may be passed to a variety of data sources/databases for future reference, such as an organization's private database or an Internet-based music or restaurant review site for use by subsequent shoppers or patrons.

According to embodiments, data generated by the photographic device 100, including photographs, recognition information about a photographed image and any data annotated/created by the photographer for the photographed image, as described above, may be stored locally on the photographic device 100 or on a chip or any other data storage repository on the object or in a website/webpage, database or any other information source associated with that photographed image for future reference by the photographer or subsequent photographer or any other users. As should be appreciated such data/information may be accessed via the photographic device 100 or via a distributed computing network. Similarly, such data/information may be readily transferred between computing devices for storage and use according to well-known data/information transfer and storage means, including electronic mail and collaborative data/information sharing systems.

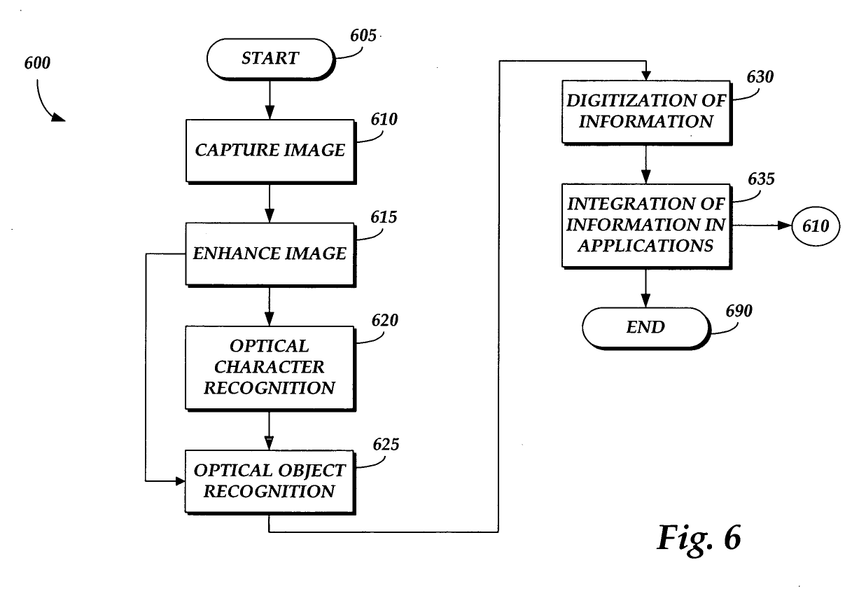

FIG. 6 is a logical flow diagram illustrating a method for providing character and object recognition with a mobile photographic and communications device 100. Having described an exemplary operating environment and aspects of embodiments of the present invention above with respect to FIGS. 1 through 5, it is advantageous to describe an example operation of an embodiment of the present invention. Referring then to FIG. 6, the method 600 begins at start operation 605 and proceeds to operation 610 where an image is captured using a camera-enabled cell phone 100, as described above.

As described above, at operation 610, the camera-enabled cell phone is used to photograph a textual or non-textual image, for example, the label 300 illustrated in FIG. 3, the business card or sign illustrated in FIG. 4, or a non-textual object, for example, a famous person or landmark (e.g., building or geographic natural structure). After the textual or non-textual image is photographed, the photographer/user may, as part of the process of capturing the image, tag or annotate the photographed image with descriptive or analytical information as described above. For example, the user may tag the photograph with a spoken, typed or electronically handwritten description for use in enhancing and improving subsequent attempts to recognize the photographed object or otherwise providing descriptive or other information for use by a subsequent user of the photograph or photographed image.

At operation 615, the photographed image along with any information tagged to the photographed image by the photographer is passed to the OCR application 265 or the OOR application 267 or both as required, and the captured image is enhanced for reading and recognition processing.

At operation 620 if the captured image includes textual content, the textual content is passed to the optical character reader/recognizer for recognizing the textual content as described above with reference to FIG. 5. At operation 625, any non-textual objects or content are passed to the optical object reader/recognizer application 267 for recognition of the non-textual content or objects as described above with reference to FIG. 5. As described above, any information previously tagged to the photographed object by a photographer may be utilized by the OCR application 265 and/or OOR application 267 in recognizing the photographed object. As should be appreciated, if the photographed content includes only non-textual information, the photographed content may be passed directly to the OOR application 267 from operation 615 to operation 625. On the other hand, if the captured image is primarily textual in nature, but also contains non-textual features, the OOR application 267 may be utilized to enhance the ability of the OCR application 265 in recognizing photographed textual content.

At operation 630, the recognition information returned by the OCR application 265 and/or the OOR application 267 is digitized and is stored for subsequent use by a target software application or by a subsequent user. For example, if the information is to be used by a word processing application, the information may be extracted by the word processing application for entry into a document. For another example, if the information is to be entered into an Internet-based search engine for obtaining helpful information on the recognized photographed object a text string identifying the photographed object may be automatically inserted into a search field of a desired search engine. That is, when the photographer or other user of the information selects a desired application, the information recognized for a photographed object or tagged to a photographed object by the photographer may be rendered by the selected application as repaired for using the information.

At operation 635, the digitized information captured by the camera cell phone 100, recognized by the OCR application 265 and/or the OOR application 267 and digitized into a suitable format is passed to one or more receiving software applications for utilizing the information on the photographed content. Alternatively, as illustrated in FIG. 6, recognized information on a photographed object or information tagged to the photographed object by the photographer may be passed back to the OCR 265 and/or OOR application 267, in conjunction with the recognition system illustrated in FIG. 5, for improving the recognition of the photographed object. A detailed discussion of various software applications that may utilize the photographed content and examples thereof are described below with reference to FIG. 7. The method ends at operation 690.

FIG. 7 illustrates a simplified block diagram showing a relationship between a captured photographic image and one or more applications or services that may utilize data associated with a captured photographic image. As described above, once a photographed image (textual and/or non-textual content) is passed through the OCR application 265 and/or OOR application 267, the resulting recognized information may be passed to one or more applications and/or services for use of the captured and processed information. As illustrated in FIG. 7, an example menu 700 is provided that may be launched on a display screen of the camera-enabled cell phone or mobile computing device 100 for allowing a user to select the type of content captured in a given photograph for assigning to one or more applications and/or services.

If the user photographs textual content from a road sign, the user may select the text option 715 for passing recognized textual content to one or more applications and/or services. On the other hand, if the user photographs a non-textual object for example, a famous building, the user may select the shapes/objects option 720 for passing a recognized non-textual object to one or more applications and/or services. On the other hand, if the captured photographic image contains recognized textual content and non-textual content, the option 725 may be selected for sending recognized textual content and non-textual content to one or more applications and/or services.

On the right-hand side of FIG. 7, a menu 710 is provided which may be displayed in the display screen of the camera-enabled cell phone or mobile computing device 100 for displaying one or more software applications available to the user's camera-enabled cell phone or mobile computing device 100 for using the captured and recognized textual and non-textural content. For example, a search application 730 may be utilized for conducting a search, for example, an Internet-based search, on the recognized content. Selecting the search application 730 may cause a text string associated with the recognized content to he automatically populated into a search window of the search application 730 for initiating a search on the recognized content. As illustrated in FIG. 7, information from the applications/services 710 may be passed back to the camera device 100 or to the captured image to allow a user to tag or annotate a photographed image with descriptive or analytical information, as described above.

An e-mail application 735 may be utilized for pasting the recognized content into the body of an e-mail message, or for locating an e-mail addressee in an associated contacts application 740. In addition, recognized content may be utilized in instant messaging applications, SMS and MMS messaging applications, as well as, desktop-type applications, for example, word processing applications, slide presentation applications, expense reporting applications, and the like.

A map/directions application 750 is illustrated into which captured and recognized content may be populated for determining directions to a location associated with a photographed image, or for determining a precise location of a photographed image. For example, a name recognized in association with a photographed object, for example, a famous building, may be passed to a global positioning system application for determining a precise location of the object. Similarly, an address photographed from a road sign may likewise be passed to the global positioning system application for learning the precise location of a building or other object associated with the photographed address.

A translator application is illustrated which may be operative for receiving an identified text string recognized by the OCR application 265 and for translating the text string from one language to another language. As should be appreciated, the software applications illustrated in FIG. 7 and described herein are for purposes of example only and are not limiting of the vast number of software applications that may utilize the captured and digitized content described herein.

A computer assisted design (CAD) application 760 is illustrated which may be operative to receive a photographed object and for utilizing the photographed object in association with design software. For example, a photograph of a car may be recognized by the OOR application 267. The recognized object may then be passed to the CAD application 760 which may render the photographed object to allow a car designer to incorporate the photographed car into a desired design.

For another example, a photographed hand sketch of a computer flowchart, such as the flowchart illustrated in FIG. 6, may be passed to a software application capable of rendering drawings, such as POWERPOINT or VISIO (both produced by MICROSOFT CORPORATION), and the hand drawn sketch may be transformed into a computer-generated drawing by the drawing software application that my be subsequently edited and utilized as desired.

The following is an example operation of the above-described process. A user photographs the name of a restaurant the user passes on a city street. The photographed name is passed to the OCR application 265 and is recognized as the name the user sees on the restaurant sign. For example, the OCR application 265 may recognize the name by comparing the photographed text string to names contained in an electronic telephone directory as described above with reference to FIG. 5. The user may then pass the recognized restaurant name to a search application to determine food review for the restaurant. If the reviews are good, the recognized name may be passed to an address directory for learning an address for the restaurant. The address may be forward to a map/directions application for finding directions to the restaurant from the location of a friend of the user. Retrieved directions may be electronically mailed to the friend to ask him/her to meet the user at the restaurant address.

It will be apparent to those skilled in the art that various modifications or variations may be made in the present invention without departing front the scope or spirit of the invention. Other embodiments of the present invention will be apparent to those skilled in the art from consideration of the specification and practice of the invention disclosed herein.

We claim:

1. A method of utilizing a photographed image in one or more software applications, comprising:
receiving a photograph of an image;
reading the photographed image and determining an identification of the photographed image;
passing the identification of the photographed image to one or more software applications; and
utilizing the identification of the photographed image via a programming associated with each of the one or more software applications.

2. The method of claim 1, wherein
wherein receiving a photograph of an image includes receiving a photograph of a text string; and
wherein reading the photographed image and determining an identification of the photographed image includes reading the photographed text string and comparing the photographed text string against one or more stored test strings for identifying the photographed text string.

3. The method of claim 2, wherein passing the identification of the photographed image to one or more software applications includes passing the identified text string to the one or more software applications.

4. The method of claim 1, wherein
wherein receiving a photograph of an image includes receiving a photograph of a non-textual object; and
wherein reading the photographed image and determining an identification of the photographed image includes reading the photographed non-textual object and comparing the photographed non-textual object against one or more stored non-textual objects for identifying the photographed non-textual object.

5. The method of claim 4, wherein passing the identification of the photographed image to one or more software applications includes passing the identified non-textual object to the one or more software applications.

6. The method of claim 1, prior to reading the photographed image and determining an identification of the photographed image, receiving an annotation to the photographed image, the annotation providing information about the photographed image.

7. The method of claim 6, wherein reading the photographed image and determining an identification of the photographed image further comprises reading any prior or new annotation to the photographed image and determining the identification of the photographed image from the annotation.

8. The method of claim 7, wherein receiving an annotation to the photographed image includes receiving descriptive information tagged to the photographed image.

9. The method of claim 7, wherein receiving an annotation to the photographed image includes receiving analytical inclination tagged to the photographed image.

10. The method of claim 2, wherein reading the photographed text string and comparing the photographed text string against one or more stored text strings for identifying the photographed text string includes reading the photographed text string and comparing the photographed text string against one or more stored test strings for identifying the photographed text string via an optical character recognizer application.

11. The method of claim 4, wherein reading the photographed non-textual object and comparing the photographed non-textual object against one or more stored non-textual objects for identifying the photographed non-textual object includes reading the photographed non-textual object and comparing the photographed non-textual object against one or more stored non-textual objects for identifying the photographed non-textual object via an optical object recognizer application.

12. The method of claim 6, further comprising storing the annotation to the photographed image and providing the annotation to the photographed image for providing information to a reviewer of the photographed image.

13. A computer readable medium containing computer executable instructions which when executed perform a method of utilizing a photographed image in one or more software applications, comprising:
receiving a photograph of an image;
receiving an annotation to the photographed image, the annotation providing information about the photographed image;
reading the photographed image and the annotation to the photographed image;
determining an identification of the photographed image;
passing the identification of the photographed image to one or more software applications: and
utilizing the photographed image via a programming associated with each of the one or more software applications.

14. The computer readable medium of claim 13, wherein
wherein receiving a photograph of an image includes receiving a photograph of a text string; and
wherein determining an identification of the photographed image includes reading the photographed text string and comparing the photographed text string against one or more stored text strings for identifying the photographed text string.

15. The computer readable medium of claim 14, wherein passing the identification of the photographed image to one or more software applications includes passing the identified text string to the one or more software applications.

16. The computer readable medium of claim 13, wherein
wherein receiving a photograph of an image includes receiving a photograph of a non-textual object; and
wherein determining an identification of the photographed image includes comparing the photographed non-textual object against one or more stored non-textual objects for identifying the photographed non-textual object.

17. The computer readable medium of claim 16, wherein passing the identification of the photographed image to one or more software applications includes passing the identified non-textual object to the one or more software applications.

18. A system for utilizing a photographed image in one or more software applications, comprising:
a mobile photographic device operative
to capture a photograph of an image;
to receive an annotation to the photographed image, the annotation providing information about the photographed image;
to pass the photograph to a recognizer application;
the recognizer application operative to determine an identification of the photographed image;
the mobile photographic device further operative
to pass the identification of the photographed image to one or more software applications; and
to utilize the photographed image via a programming associated with each of the one or more software applications.

19. The system of claim 18, wherein the recognizer application is further operative to compare the photographed image against one or more stored images for identifying the photographed image.

20. The system of claim 19, wherein the mobile photographic device is further operative
to store the annotation to the photographed image; and to provide the annotation to a subsequent reviewer of the photographed image for providing information about the photographed image to the subsequent reviewer.
